(19) United States
(12) Patent Application Publication
(10) Pub. No.: US 2026/0019419 A1
(43) Pub. Date: Jan. 15, 2026

(54) SYSTEM, SERVER APPARATUS, CONTROL METHOD OF SERVER APPARATUS, AND NON-TRANSITORY COMPUTER-READABLE STORAGE MEDIUM

(71) Applicant: NEC Corporation, Tokyo (JP)

(72) Inventors: Yuta KOBAYASHI, Tokyo (JP); Takeshi Yamaguchi, Tokyo (JP); Masayuki Naitou, Tokyo (JP)

(73) Assignee: NEC Corporation, Tokyo (JP)

(21) Appl. No.: 19/250,235

(22) Filed: Jun. 26, 2025

(30) Foreign Application Priority Data
Jul. 12, 2024 (JP) 2024-112253

(51) Int. Cl. H04L 9/40

(52) U.S. Cl. CPC H04L 63/0861; H04L 63/0823

(57) ABSTRACT

A system includes a regional application server, a metaverse server, and an authentication server. The authentication server authenticates a user who attempts to log in to the regional application server and the metaverse server. In a case where the user determined to have succeeded in the authentication experiences content related to the predetermined region, the metaverse server grants a benefit that can be enjoyed in the predetermined region to the user who experienced the content and issues a certificate of the granted benefit. In a case where the user determined to have succeeded in the authentication desires to enjoy the granted benefit, the regional application server acquires the certificate of the granted benefit and performs control related to a provision of the benefit by using the acquired certificate.

### INCORPORATION BY REFERENCE

This application is based upon and claims the benefit of priority from Japanese Patent Application No. 2024-112253, filed on Jul. 12, 2024, the disclosure of which is incorporated herein in its entirety by reference.

### TECHNICAL FIELD

The present invention relates to a system, a server apparatus, a control method of a server apparatus, and a non-transitory computer-readable storage medium.

### BACKGROUND ART

There exists a technology for associating actions of a user in a virtual space with actions in a real space.

For example, Patent Literature 1 (JP2024-029487) describes an information processing system that provides a user with a system which associates an action in a real space and an action in a virtual space with each other.

The information processing system of Patent Literature 1 includes a mission generation unit, a terminal, a display, a GPS (Global Positioning System) receiver, an execution determination unit, a virtual benefit information issuing unit, and an action permission unit. The mission generation unit generates a mission to be executed in the real space.

The terminal acquires the mission generated by the mission generation unit. The display presents content of the mission acquired by the terminal. The GPS receiver acquires a current position. The execution determination unit determines, based on the mission acquired by the terminal and the current position acquired by the GPS receiver, whether or not the mission is being executed. The virtual benefit information issuing unit issues virtual benefit information which includes content executable in the virtual space, in a case where the execution determination unit determines that the mission is being executed. The action permission unit permits an executable action in the virtual space based on the virtual benefit information issued by the virtual benefit information issuing unit.

As disclosed in Patent Literature 1, there are cases where actions of a user in a virtual space are associated with actions of the user in a real world. For example, a benefit that can be enjoyed in the real world may be granted in response to an action of a user in a virtual space (metaverse).

In order to realize such granting of benefits, it is necessary that the user who acts in the virtual space and the user who acts in the real space be the same individual. However, a system that guarantees such identity does not exist, including the system of Patent Literature 1.

### SUMMARY

It is a main object of the present invention to provide a system, a server apparatus, a control method of a server apparatus, and a non-transitory computer-readable storage medium that contribute to realizing the granting of a benefit, which can be enjoyed in a real space, in response to an action in a virtual space, while ensuring the identity of a user who acts in both the virtual space and the real space.

According to a first aspect of the present invention, there is provided a system, including: a regional application server that provides a service related to a predetermined region; a metaverse server that provides content related to the predetermined region on a metaverse; and an authentication server that authenticates a user who attempts to log in to the regional application server and the metaverse server, wherein the authentication server notifies, in a case where the authentication server succeeds in authenticating the user who attempts to log in to the metaverse server, the metaverse server of a success of an authentication of the user, and wherein the metaverse server, in a case where the user determined to have succeeded in the authentication experiences the content related to the predetermined region, grants a benefit that can be enjoyed in the predetermined region to the user who experienced the content and issues a certificate of the granted benefit, and wherein the authentication server notifies, in a case where the authentication server succeeds in authenticating the user who attempts to log in to the regional application server, the regional application server of a success of an authentication of the user, and wherein the regional application server acquires, in a case where the user determined to have succeeded in the authentication desires to enjoy the granted benefit, the certificate of the granted benefit and performs control related to a provision of the benefit by using the acquired certificate.

According to a second aspect of the present invention, there is provided a server apparatus, including: a storage means that stores biometric information of each of a plurality of users; and an authentication control means that authenticates a person to be authenticated who attempts to log in to a regional application server that provides a service related to a predetermined region or to a metaverse server that provides content related to the predetermined region on a metaverse using the stored biometric information and the biometric information of the person to be authenticated.

According to a third aspect of the present invention, there is provided a control method of a server apparatus, the control method including: storing biometric information of each of a plurality of users; and authenticating a person to be authenticated who attempts to log in to a regional application server that provides a service related to a predetermined region or to a metaverse server that provides content related to the predetermined region on a metaverse using the stored biometric information and the biometric information of the person to be authenticated.

According to a fourth aspect of the present invention, there is provided a non-transitory computer-readable storage medium storing a program causing a computer mounted on a server apparatus to perform processing for: storing biometric information of each of a plurality of users; and authenticating a person to be authenticated who attempts to log in to a regional application server that provides a service related to a predetermined region or to a metaverse server that provides content related to the predetermined region on a metaverse using the stored biometric information and the biometric information of the person to be authenticated.

### BRIEF DESCRIPTION OF THE DRAWINGS

Exemplary features and advantages of the present invention will become apparent from the following detailed description when taken with the accompanying drawings in which:

FIG. 1 is a diagram illustrating an outline of an example embodiment;

FIG. 2 is a flowchart illustrating an operation of an example embodiment;

FIG. 3 is a diagram illustrating an example of a schematic configuration of an information processing system according to an embodiment of the present disclosure;

FIG. 4 is a diagram illustrating an operation of the information processing system according to the embodiment of the present disclosure;

FIG. 5 is a diagram illustrating the operation of the information processing system according to the embodiment of the present disclosure;

FIG. 6 is a diagram illustrating the operation of the information processing system according to the embodiment of the present disclosure;

FIG. 7 is a diagram illustrating the operation of the information processing system according to the embodiment of the present disclosure;

FIG. 8 is a diagram illustrating an example of a processing configuration of an authentication server according to the embodiment of the present disclosure;

FIG. 9 is a diagram illustrating an example of a user management database according to the embodiment of the present disclosure;

FIG. 10 is a flowchart illustrating an example of an operation of an authentication control unit according to the embodiment of the present disclosure;

FIG. 11 is a diagram illustrating an example of a processing configuration of a metaverse server according to the embodiment of the present disclosure;

FIG. 12 is a diagram illustrating an example of a display of a terminal according to the embodiment of the present disclosure;

FIG. 13 is a diagram illustrating an example of the display of the terminal according to the embodiment of the present disclosure;

FIG. 14 is a diagram illustrating an example of a processing configuration of a regional application server according to the embodiment of the present disclosure;

FIG. 15 is a diagram illustrating an example of the display of the terminal according to the embodiment of the present disclosure;

FIG. 16 is a diagram illustrating an example of the display of the terminal according to the embodiment of the present disclosure;

FIG. 17 is a diagram illustrating an example of a display of a staff terminal according to the embodiment of the present disclosure;

FIG. 18 is a sequence diagram illustrating an example of the operation of the information processing system according to the embodiment of the present disclosure; and

FIG. 19 is a diagram illustrating an example of a hardware configuration of an authentication server according to the present disclosure.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

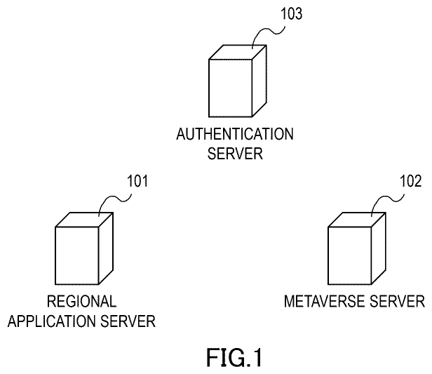

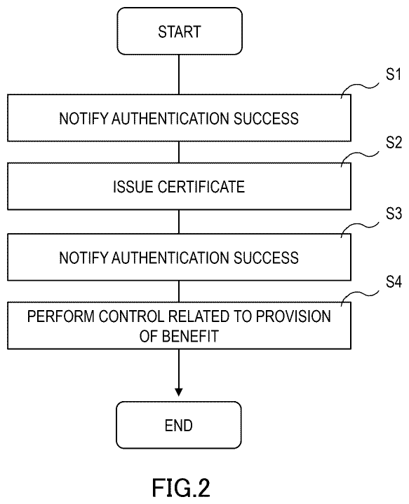

A system according to an example embodiment includes a regional application server 101, a metaverse server 102, and an authentication server 103 (see FIG. 1). The regional application server 101 provides a service related to a predetermined region. The metaverse server 102 provides content related to the predetermined region on a metaverse. The authentication server 103 authenticates a user who attempts to log in to the regional application server 101 and the metaverse server 102. In a case where the authentication server 103 succeeds in authenticating the user who attempts to log in to the metaverse server 102, the authentication server 103 notifies the metaverse server 102 of a success of an authentication of the user (step S1 in FIG. 2). In a case where the user determined to have succeeded in the authentication experiences content related to the predetermined region, the metaverse server 102 grants a benefit that can be enjoyed in the predetermined region to the user who experienced the content and issues a certificate of the granted benefit (step S2). In a case where the authentication server 103 succeeds in authenticating the user who attempts to log in to the regional application server 101, the authentication server 103 notifies the regional application server 101 of the success of the authentication of the user (step S3). In a case where the user determined to have succeeded in the authentication desires to enjoy the granted benefit, the regional application server 101 acquires the certificate of the granted benefit and performs control related to a provision of the benefit by using the acquired certificate (step S4).

The metaverse server 102 grants the benefit that can be enjoyed in the real world to the user who has experienced content related to a region on the metaverse, and issues the certificate related to the benefit. In a case where the user to whom the benefit has been granted desires to enjoy (use) the benefit, the regional application server 101 acquires the corresponding certificate. The regional application server 101 performs control related to the provision of the benefit by using the acquired certificate. Further, the regional application server 101 and the metaverse server 102 authenticate (specify) a user who experiences content and a user who enjoys a benefit by using a common authentication infrastructure provided by the authentication server 103. The authentication server 103 ensures the identity of a user who acts in a virtual space (metaverse) and in a real space by authenticating a person to be authenticated. That is, the fact that the user who acts in the virtual space and the user who uses a benefit that can be enjoyed in the real space are the same is ensured by authentication by the authentication server 103. The system ensures that “the person who has acquired a right or the like on the metaverse” and “the person who exercises the right in the real world” are the same person.

Hereinafter, specific example embodiments will be described in more detail with reference to drawings.

### First Example Embodiment

A first example embodiment will be described in more detail with reference to drawings.

In the information processing system according to the first example embodiment, a user experiences content related to a region having a sightseeing area or a sightseeing spot on a virtual space (metaverse). A user who has experienced the content on the metaverse is granted a benefit that can be enjoyed in a region (such as a sightseeing area in the real world) corresponding to the experienced content.

The information processing system according to the first example embodiment realizes revitalization of a regional economy by granting a benefit that can be enjoyed in the real world to a user who has acted on a metaverse related to the region. That is, the information processing system according to the first example embodiment sends users on the metaverse to the real world (such as a sightseeing area or sightseeing spot).

In the following description, content related to a region is referred to as “regional content.” Further, a metaverse that provides the regional content to a user is referred to as a “regional metaverse.”

### System Configuration

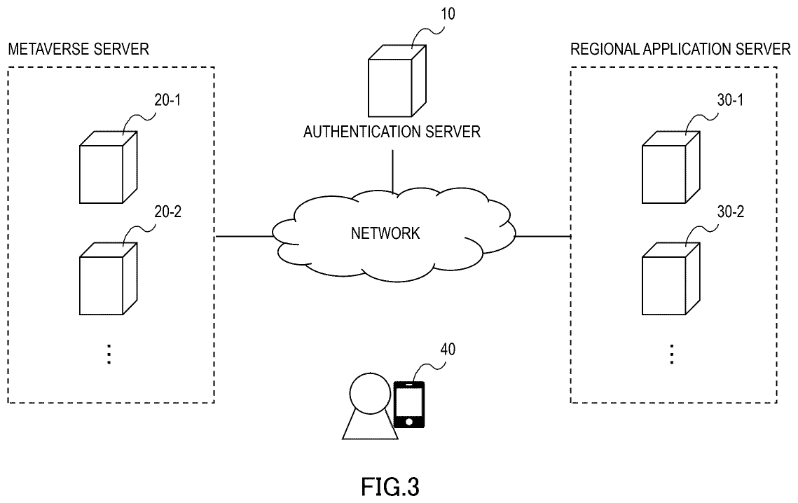

As shown in FIG. 3, the information processing system according to the first example embodiment includes an authentication server 10, a plurality of metaverse servers 20-1 and 20-2, and a plurality of regional application servers 30-1 and 30-2.

A user possesses a terminal 40 such as a smartphone or a head mounted display (HMD). The user operates the terminal 40 to access the metaverse server 20, the regional application server 30, or the like. The user may selectively use the smartphone and the HMD depending on the server to be connected to, or may use the same device.

For example, a user may use the HMD in a case where the user accesses the metaverse server 20, and may use the smartphone in a case where the user accesses the regional application server 30. Alternatively, the user may access the metaverse server 20, the regional application server 30, or the like using the same device.

The authentication server 10 is a server that provides an authentication service. More specifically, the authentication server 10 provides an authentication service using biometric information. More specifically, the authentication server 10 authenticates a user who attempts to log in to the metaverse server 20 or the regional application server 30. The authentication server 10 may be installed in a building of a business operator that provides the authentication service, or may be installed on a network (on a cloud).

The metaverse servers 20-1 and 20-2 are servers that provide content related to a predetermined region (a region having a sightseeing area or the like) on a metaverse.

In the following description, unless there is a particular reason to distinguish the metaverse servers 20-1 and 20-2 from each other, any one of these metaverse servers 20-1 and 20-2 will simply be referred to as a “metaverse server 20”. Similarly, regarding the regional application servers 30-1 and 30-2, they are simply referred to as a “regional application server 30” unless there is a particular reason to distinguish between the regional application servers 30-1 and 30-2.

The metaverse server 20 is installed corresponding to a region having a sightseeing area or the like. The metaverse server 20 provides regional content related to the corresponding region (a sightseeing area, a sightseeing spot) on a metaverse. For example, the metaverse server 20-1 provides regional content of a region A, and the metaverse server 20-2 provides regional content of a region B.

The metaverse server 20 provides, as regional content, content on a metaverse that makes a user want to visit a region (a sightseeing area, a sightseeing spot) corresponding to the regional content. For example, the metaverse server 20 provides regional content that allows the user to feel characteristics or atmosphere of the region.

Alternatively, the metaverse server 20 may provide a metaverse (regional metaverse) in which a field modeled on a predetermined region is prepared and a persona (virtual person) of a user freely moves on the field.

The metaverse server 20 may be managed and operated by a regional tourist association or the like, or may be managed and operated by a business operator entrusted by the tourist association or the like. The metaverse server 20 may be installed in a building of a management association or a business operator entrusted thereby, or may be installed on a network (on a cloud).

The regional application server 30, similarly to the metaverse server 20, is installed corresponding to a region having a sightseeing area or the like. The regional application server 30 is a server that provides a service related to a region (for example, an information providing service) and a wallet service.

The information providing service is a service that provides a user with sightseeing information related to a shop or the like operating at a sightseeing spot or sightseeing area. For example, the regional application server 30-1 provides the user with sightseeing information related to a region A, and the regional application server 30-2 provides the user with sightseeing information related to a region B.

The wallet service is a service related to a wallet that manages an NFT or the like issued to a user. The user is able to access the wallet via the regional application server 30.

Here, a user installs a regional application on the terminal 40 in order to receive a service from the metaverse server 20 or the regional application server 30. It should be noted that the regional application may not be a dedicated application requiring installation, but may be a WEB (web) application using a browser. The regional application server 30 is also a server that provides a principal function related to the regional application.

The user uses the regional application to log in to the metaverse server 20 and the regional application server 30. Further, the user is able to enjoy the above-described information providing service, the wallet service, and other services related to a sightseeing area via the regional application.

It should be noted that the regional application is prepared for each region having a sightseeing area or the like. In the above example, a regional application for the region A and a regional application for the region B exist, respectively. The user installs a regional application corresponding to a region of interest on the terminal 40.

Each apparatus shown in FIG. 3 is connected to a network. Specifically, the authentication server 10, the metaverse server 20, the regional application server 30, and the terminal 40 are connected to the network by wired or wireless communication means.

The configuration of the information processing system shown in FIG. 3 is an example and is not intended to limit the configuration of the information processing system. For example, a plurality of authentication servers 10 may be included in the system. Load distribution and redundancy may be realized by the plurality of authentication servers 10. Further, the information processing system only needs to include at least one or more metaverse servers 20 and at least one or more regional application servers 30.

### Schematic Operation

Next, a schematic operation of the information processing system according to the first example embodiment will be described.

### <Generation of Account>

A user generates an account on the authentication server 10 in order to receive a service from the information processing system.

For example, the user activates the regional application. In a case where the user performs a predetermined operation (for example, pressing a user registration button), the terminal 40 (the regional application) accesses the authentication server 10.

The user inputs information such as a name, a gender, a date of birth, an address, biometric information, and contact information (for example, a telephone number or an email address) into the authentication server 10. The authentication server 10 generates an account of the user after acquiring information such as the name of the user.

Further, the authentication server 10 generates a “wallet” of the user. After generating an account of the user, the authentication server 10 generates a wallet (wallet address) for managing an NFT (Non-Fungible Token) or the like issued to the user. The authentication server 10 stores the generated wallet address in the account.

Further, the authentication server 10 transmits all or a part of the information stored in the generated account to the metaverse server 20 and the regional application server 30 corresponding to the regional application. The authentication server 10 transmits at least the wallet address to the metaverse server 20 and the regional application server 30.

The metaverse server 20 and the regional application server 30 that have received the wallet address or the like generate an account of the user.

It should be noted that examples of the biometric information include data (feature values) calculated from physical features unique to an individual, such as a face, a fingerprint, a voiceprint, a vein, a retina, or an iris pattern of an eye. Alternatively, the biometric information may be image data such as a face image or a fingerprint image. The biometric information may be anything that includes physical characteristics of a user as information. In the embodiment disclosed in the present application, a case where biometric information related to a human “face” (a face image or a feature value generated from the face image) is used will be described.

Here, the wallet address is used as a common ID for identifying a user in the authentication server 10, the metaverse server 20, and the regional application server 30. In the following description, the wallet address is referred to as a common ID.

### <Experiencing Content on Regional Metaverse>

A user who has generated an account in the authentication server 10 or the like is able to experience regional content on a regional metaverse. In order to experience content on the regional metaverse, the user logs in to the metaverse server 20.

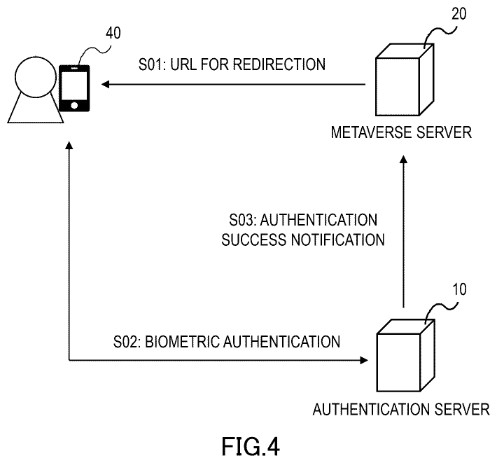

In a case where the user logs in to the metaverse server 20, authentication linkage is performed between the authentication server 10 and the metaverse server 20 (see FIG. 4).

For example, in a case where a user performs a predetermined operation (for example, pressing a regional content experience button) in the regional application, the regional application (the terminal 40) accesses the metaverse server 20.

The metaverse server 20 that has received the access redirects a connection destination of the terminal 40 to the authentication server 10. The metaverse server 20 transmits a URL for redirection to the terminal 40 (step S01). The terminal 40 accesses the authentication server 10 as the redirection destination.

The authentication server 10 performs biometric authentication of the user (the user who attempts to log in to the metaverse server 20) (step S02).

The authentication server 10 transmits an authentication result to the metaverse server 20. Specifically, in a case where the authentication succeeds, the authentication server 10 transmits an authentication success notification including the common ID (the wallet address) of the user to the metaverse server 20 (step S03).

The metaverse server 20 identifies the user who has logged in to an account by using the common ID (the wallet address).

The user who has logged in to the account of the metaverse server 20 experiences regional content on the regional metaverse. In a case where the user experiences the regional content, the metaverse server 20 grants a benefit to the user.

For example, the metaverse server 20 grants the user, as the benefit, eligibility to participate in an event (an event ticket) held in a region corresponding to the regional content (a region in the real world). For example, the concert ticket for an idol or the like held in a sightseeing area is granted to the user as the benefit. For example, the concert is an event limited to users who have experienced content specialized for the region

The metaverse server 20 issues a certificate for the benefit (for example, an event ticket) granted to the user. The metaverse server 20 issues the certificate proving that the user is able to enjoy the benefit.

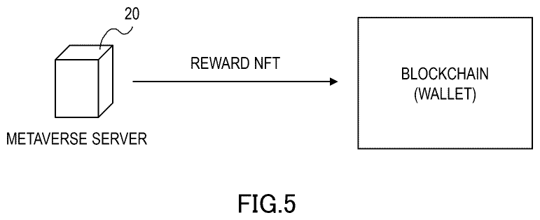

For example, the metaverse server 20 issues an NFT corresponding to a benefit granted to the user (see FIG. 5). The metaverse server 20 issues an NFT (an NFT as a ticket) in which the user who has experienced the regional content on the regional metaverse is set as an owner and a manager of the regional metaverse (for example, a regional tourist association) is set as an issuer.

It should be noted that, in the following description, a ticket granted to the user as the benefit is referred to as a “reward ticket.” Further, an NFT corresponding to the reward ticket is referred to as a “reward NFT.”

A person in charge of a tourist association or the like generates a smart contract for issuing the reward NFT and deploys the generated smart contract on a blockchain.

The metaverse server 20 that needs to issue the reward NFT calls a function of the smart contract and inputs information necessary for issuing the reward NFT (for example, a user ID, a tourist association ID, and details of the ticket).

It should be noted that the common ID (the wallet address) is used as the user ID. The tourist association ID may be a wallet address or another ID. The details of the ticket include an event name, information of an event venue, an event holding date and time, or the like.

By executing the smart contract, the wallet (wallet address) of the user and the reward NFT are associated with each other.

### <Visiting Sightseeing Area>

The user who has acquired the reward NFT visits a sightseeing area in order to participate in an event. The user who has arrived at the sightseeing area activates the regional application. The user logs in to an account of the regional application server 30 via the regional application. At that time, the regional application server 30 performs authentication linkage with the authentication server 10 similarly to the metaverse server 20.

In a case where authentication of the user succeeds, the authentication server 10 transmits an authentication success notification including the common ID (the wallet address) of the user to the regional application server 30. The regional application server 30 identifies the user who has logged in to the account by using the common ID (the wallet address).

The regional application server 30 provides regional sightseeing information to the user who has logged in to the account and distributes a coupon. The regional application server 30 provides the sightseeing information and distributes the coupon via the regional application.

### <Using Reward Ticket>

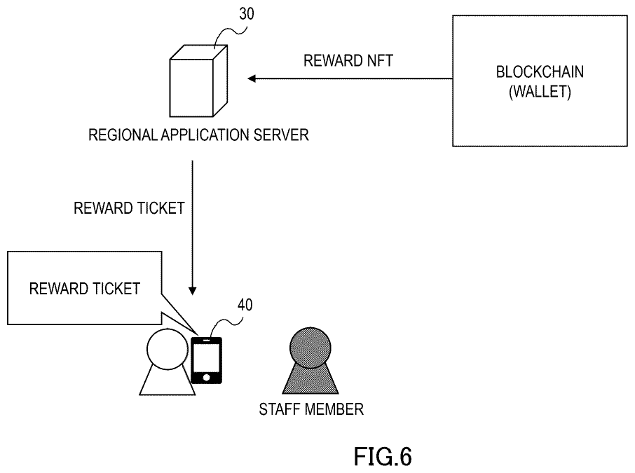

The user uses the benefit (the reward ticket) in the sightseeing area (see FIG. 6). Specifically, the user enters an event venue using the reward ticket.

At that time, the user operates the regional application at an entrance of the event venue. For example, the user presses a “ticket use button” displayed on a screen of the regional application. In response to the operation, the regional application server 30 acquires the reward NFT owned by the user from the wallet of the user.

The regional application server 30 displays information of the reward ticket, acquired from the obtained reward NFT, on the terminal 40. For example, the terminal 40 displays an event name, an event venue name, an event holding date and time, or the like.

The user presents the terminal 40, on which the reward ticket is displayed, to a staff member of an event organizer. In a case where the presented reward ticket is valid, the staff member permits the user to enter the event venue.

Here, the regional application server 30 may be provided with a mechanism for preventing unauthorized use of a reward ticket. For example, the regional application server 30 prevents unauthorized activities in which an unauthorized third party attempts to enter an event venue by presenting a screenshot of a reward ticket to a staff member.

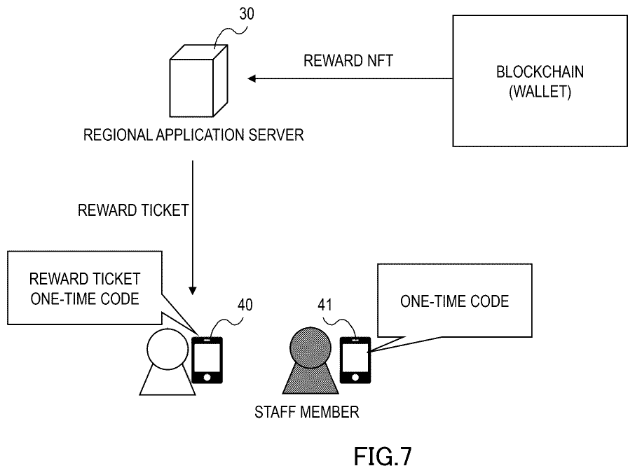

Specifically, the regional application server 30 displays a one-time code together with the reward ticket (specific content of the reward ticket) on the terminal 40 via the regional application (see FIG. 7). More specifically, the regional application server 30 displays a one-time code updated at a predetermined interval (for example, at an interval of 10 seconds) on the terminal 40.

Further, the regional application server 30 displays the same one-time code as that displayed on the terminal 40 also on a staff terminal 41 possessed by a staff member of an event venue. The staff member of the event venue compares the one-time code displayed on the staff terminal 41 with the one-time code displayed on the terminal 40 of the user.

In a case where the two one-time codes are identical, the staff member determines that the user owns a legitimate reward ticket and permits the user to enter the event venue. In a case where the two one-time codes are different, the staff member determines that the user does not own a legitimate reward ticket and refuses to permit the user to enter the event venue.

As described above, in a case where the authentication server 10 succeeds in authenticating a user who attempts to log in to the metaverse server 20, the authentication server 10 notifies the metaverse server 20 that the authentication of the user has succeeded. The metaverse server 20, in a case where the user determined to have succeeded in authentication experiences content related to a predetermined region, grants a benefit that can be enjoyed in the predetermined region to the user who has experienced the content and issues a certificate of the granted benefit. In a case where the authentication server 10 succeeds in authenticating the user who attempts to log in to the regional application server 30, the authentication server 10 notifies the regional application server 30 that the authentication of the user has succeeded. The regional application server 30, in a case where the user determined to have succeeded in authentication desires to enjoy the granted benefit, acquires a certificate of the benefit granted to the user and performs control related to provision of the benefit by using the acquired certificate.

The metaverse server 20 may issue an NFT (Non-Fungible Token) as the certificate of the benefit granted to the user. Further, the metaverse server 20 may grant, as a benefit that can be enjoyed in a predetermined region, a ticket for an event held in the predetermined region to the user who has experienced the content.

The regional application server 30 may display information related to a reward ticket acquired from a reward NFT on the terminal 40 possessed by the user who has logged in to the regional application server 30 and attempts to enter the event venue using the ticket. At that time, the regional application server 30 may display, together with information related to the reward ticket, a one-time code updated at a predetermined interval on the terminal 40.

Next, details of the individual apparatuses included in the information processing system according to the first example embodiment will be described.

### [Authentication Server]

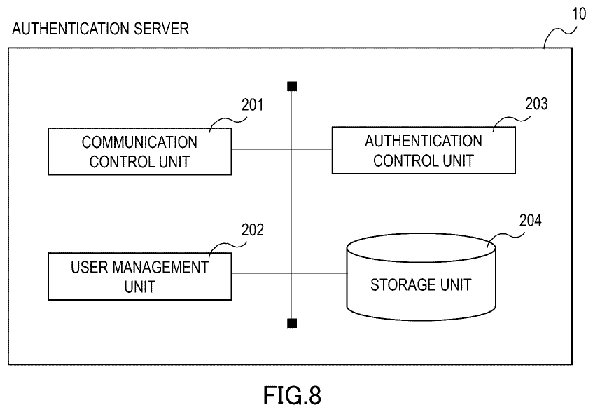

FIG. 8 is a diagram illustrating an example of a processing configuration (processing modules) of the authentication server 10 according to an example embodiment of the present application. Referring FIG. 8, the authentication server 10 includes a communication control unit 201, a user management unit 202, an authentication control unit 203, and a storage unit 204.

The communication control unit 201 is means for controlling communication with other apparatuses. For example, the communication control unit 201 receives data (packets) from the metaverse server 20. In addition, the communication control unit 201 transmits data to the metaverse server 20. The communication control unit 201 passes data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The user management unit 202 is means for performing management of a user or the like.

The user management unit 202 acquires information such as a name, a gender, a date of birth, an address, biometric information, and contact information (a telephone number, an email address, or the like) of a user on a website or the like for user registration.

In a case where a face image is acquired as biometric information, the user management unit 202 generates a feature value from the face image.

It should be noted that since an existing technology can be used to generate the feature value, a detailed description thereof will be omitted. For example, the user management unit 202 extracts eyes, a nose, a mouth, or the like as feature points from a face image. Thereafter, the user management unit 202 calculates a position of each feature point and a distance between feature points as feature values and generates a feature vector composed of a plurality of feature values (vector information characterizing the face image).

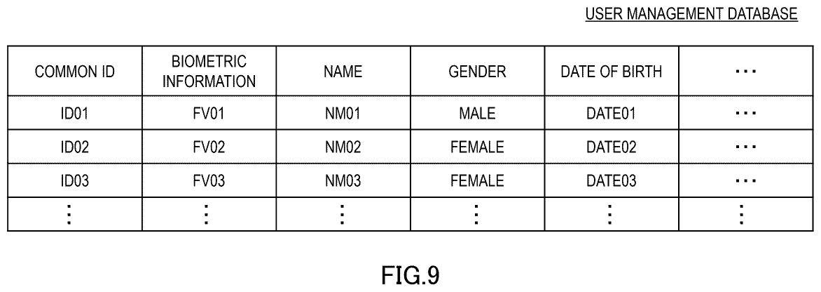

Further, the user management unit 202 generates a “wallet” of the user. More specifically, the user management unit 202 generates a public key, a private key, and a wallet address of the user. The user management unit 202 stores the wallet address as a common ID in a user management database (see FIG. 9). It should be noted that the user management database shown in FIG. 9 is an example, and is not intended to limit items to be stored or the like.

Further, the user management unit 202 transmits all or a part of information stored in an account to the metaverse server 20 and the regional application server 30. Specifically, the user management unit 202 transmits a common ID, a name, a gender, a date of birth, an address, contact information, or the like to the metaverse server 20 and the regional application server 30 corresponding to a region for which a regional application has been installed by a user.

The authentication control unit 203 is means for performing control related to authentication of a user who attempts to log in to the metaverse server 20 or the regional application server 30.

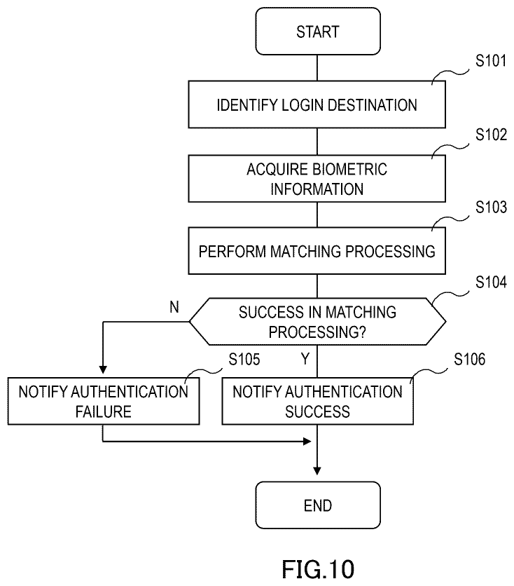

FIG. 10 is a flowchart illustrating an example of an operation of the authentication control unit 203 according to the embodiment disclosed in the present application. Referring to FIG. 10, the operation of the authentication control unit 203 will be described.

The authentication control unit 203 identifies a login destination of a user based on a page accessed by the terminal 40 in accordance with a URL for redirection (step S101).

Specifically, in a case where the terminal 40 accesses a page for the metaverse server 20, the metaverse server 20 is identified as a server to which the user logs in. In a case where the terminal 40 accesses a page for the regional application server 30, the regional application server 30 is identified as a server to which the user logs in.

The authentication control unit 203 acquires biometric information of a person to be authenticated (a user who attempts to log in to the metaverse server 20 or the regional application server 30) (step S102). Specifically, the authentication control unit 203 requests the terminal 40 to provide biometric information. For example, the authentication control unit 203 instructs the terminal 40 to acquire a face image of the person to be authenticated by self-photographing. The authentication control unit 203 acquires biometric information (for example, a face image) of the user from the terminal 40.

In a case where the face image of the user is acquired, the authentication control unit 203 performs a matching processing using the acquired face image and biometric information stored in a user management database (step S103).

Specifically, the authentication control unit 203 generates a feature value from the acquired face image. The authentication control unit 203 sets the generated feature value as a matching target and performs a matching processing (one-to-N matching; N is a positive integer, the same shall apply hereinafter) with feature values registered in the user management database.

The authentication control unit 203 calculates a similarity between the feature value to be matched and each of the plurality of feature values on the registration side. The similarity may be calculated using a chi-square distance, a Euclidean distance, or the like. It should be noted that a longer distance represents a lower similarity, and a shorter distance represents a higher similarity.

The authentication control unit 203 determines that the matching processing has failed in a case where none of the plurality of feature values registered in the user management database has a similarity with the feature value as the matching target that is equal to or greater than a predetermined value.

The authentication control unit 203 determines that the matching processing has succeeded in a case where at least one of the plurality of feature values registered in the user management database has a similarity with the feature value as the matching target that is equal to or greater than a predetermined value. In a case where the matching processing succeeds, a user (entry) corresponding to a feature value having the greatest similarity with the feature value as the matching target is specified as the person to be authenticated.

In a case where the matching processing fails (step S104, No branch), the authentication control unit 203 notifies the terminal 40 (the regional application) of the user that the authentication has failed (step S105).

In a case where the matching processing succeeds (step S104, Yes branch), the authentication control unit 203 notifies the metaverse server 20 or the regional application server 30 that the authentication has succeeded (step S106). In this case, the authentication control unit 203 transmits an authentication success notification including a common ID of the person to be authenticated, specified by the matching processing, to the login destination (the metaverse server 20 or the regional application server 30).

As described above, the authentication control unit 203 authenticates a person to be authenticated who attempts to log in to the regional application server 30 that provides a service related to a predetermined region or to the metaverse server 20 that provides content related to the predetermined region on a metaverse. The authentication control unit 203 authenticates the person to be authenticated using biometric information stored in the user management database and biometric information of the person to be authenticated.

The storage unit 204 is means for storing information necessary for the operation of the authentication server 10. For example, the storage unit 204 stores biometric information of each of a plurality of users. Alternatively, the storage unit 204 stores an ID of a regional application and information (for example, addresses) of the corresponding metaverse server 20 and regional application server 30 or the like in association with each other.

### [Metaverse Server]

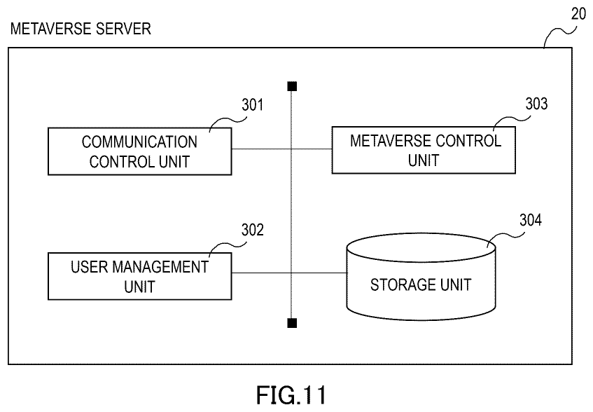

FIG. 11 is a diagram illustrating an example of a processing configuration (processing modules) of the metaverse server 20 according to the embodiment disclosed in the present application. Referring to FIG. 11, the metaverse server 20 includes a communication control unit 301, a user management unit 302, a metaverse control unit 303, and a storage unit 304.

The communication control unit 301 is means for controlling communication with other apparatuses. For example, the communication control unit 301 receives data (packets) from the authentication server 10. Also, the communication control unit 301 transmits data toward the authentication server 10. The communication control unit 301 passes data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

The user management unit 302 is means for performing management of a user or the like.

The user management unit 302 receives a common ID, a name, a gender, or the like of the user from the authentication server 10. The user management unit 302 stores the acquired common ID, name, or the like in a database.

Further, in a case where the terminal 40 accesses a predetermined website (a login page), the user management unit 302 transmits a URL for redirection for redirecting the terminal 40 to the authentication server 10 to the terminal 40.

The user management unit 302, upon receiving an authentication success notification from the authentication server 10, passes a common ID (a wallet address) included in the authentication success notification to the metaverse control unit 303.

The metaverse control unit 303 is means for performing control related to a regional metaverse. More specifically, the metaverse control unit 303 provides regional content to a user on the regional metaverse.

The metaverse control unit 303 identifies the user who has logged in based on the common ID acquired from the user management unit 302. The metaverse control unit 303 provides the regional content to the user.

A person in charge of a tourist association or the like creates regional content and registers the created regional content in the metaverse server 20. It should be noted that the person in charge of the tourist association or the like may register a plurality of pieces of regional content in the metaverse server 20.

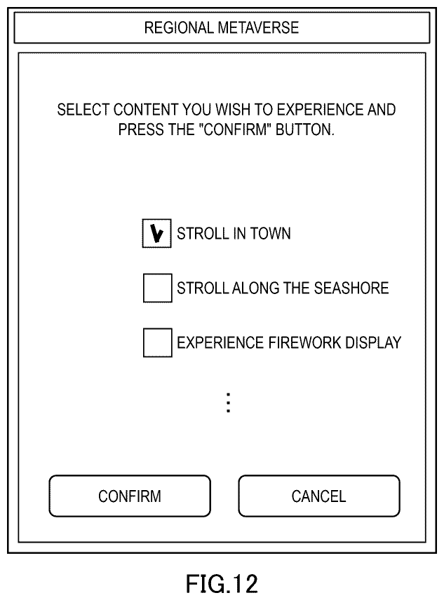

In this case, the metaverse control unit 303 may acquire regional content that the user desires to experience from among the plurality of pieces of regional content by using a GUI (Graphical User Interface) or the like. For example, the metaverse control unit 303 may display a GUI as shown in FIG. 12 on the terminal 40 and specify regional content that the user desires to experience.

In a case where the user finishes experiencing the regional content, the metaverse control unit 303 grants a benefit to the user in response to the experience of the regional content. For example, the metaverse control unit 303 grants a ticket for an event held in a sightseeing area or the like in the real world to the user as the benefit.

The metaverse control unit 303 issues a certificate of the benefit granted to the user. More specifically, the metaverse control unit 303 issues an NFT of a reward ticket granted to the user. More specifically, the metaverse control unit 303 issues an NFT for proving that the user can participate in an event by using the wallet address of the user. The metaverse control unit 303 calls a function of a smart contract deployed on a node on a blockchain and issues a reward NFT of the reward ticket.

For example, the metaverse control unit 303 respectively inputs a common ID (wallet address) as an address of an NFT holder and a wallet address of a tourist association as an ID of an NFT issuer into a smart contract. Further, the metaverse control unit 303 inputs, as information related to a reward ticket granted to a user, an event name, information of an event venue, an event holding date, or the like into the smart contract.

The smart contract, using these pieces of information, issues an NFT in which the user who has experienced the regional content is set as an owner, a tourist association is set as an issuer, and information related to the reward ticket is included in metadata.

It should be noted that issuance of an NFT using a smart contract is not the gist of the present disclosure, and therefore, a more detailed description thereof will be omitted.

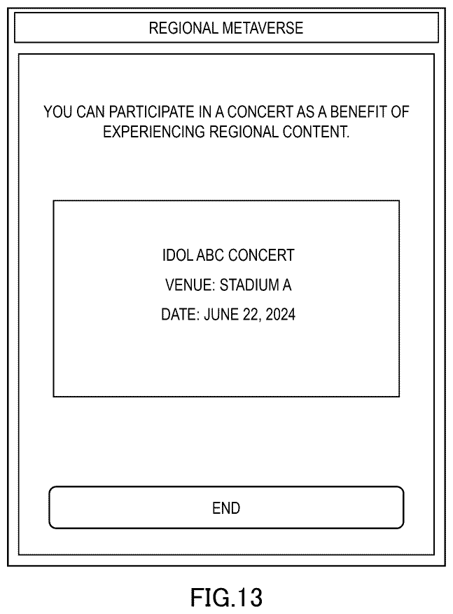

In a case where the reward NFT is successfully issued, the metaverse control unit 303 displays a screen as shown in FIG. 13 on the terminal 40 (the regional application).

The storage unit 304 is means for storing information necessary for the operation of the metaverse server 20.

### [Regional Application Server]

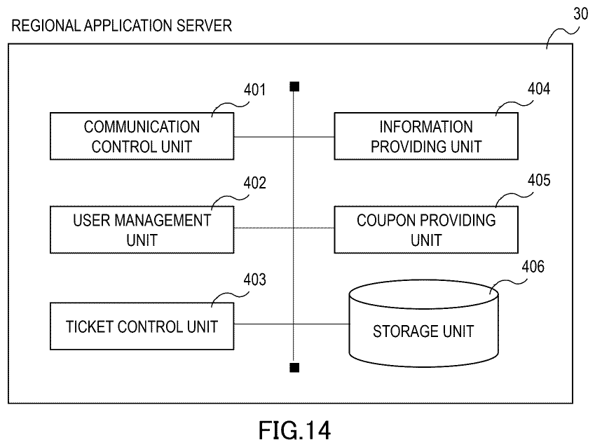

FIG. 14 is a diagram illustrating an example of a processing configuration (processing modules) of the regional application server 30 according to the embodiment disclosed in the present application.

Referring to FIG. 14, the regional application server 30 includes a communication control unit 401, a user management unit 402, a ticket control unit 403, an information providing unit 404, a coupon providing unit 405, and a storage unit 406.

The communication control unit 401 is means for controlling communication with other apparatuses. For example, the communication control unit 401 receives data (packets) from the authentication server 10. Also, the communication control unit 401 transmits data toward the authentication server 10. The communication control unit 401 passes data received from other apparatuses to other processing modules. The communication control unit 401 transmits data acquired from other processing modules to other apparatuses. In this way, other processing modules transmit and receive data to and from other apparatuses via the communication control unit 401. The communication control unit 401 includes a function as a receiving unit for receiving data from other apparatuses, and a function as a transmitting unit for transmitting data to other apparatuses.

The user management unit 402 is means for performing management of a user or the like.

The user management unit 402 receives a common ID, a name, a gender, or the like of a user from the authentication server 10. The user management unit 402 stores the acquired common ID, name, or the like in a database.

Further, in a case where the terminal 40 accesses a predetermined website (a login page), the user management unit 402 transmits a URL for redirection for redirecting the terminal 40 to the authentication server 10 to the terminal 40.

Upon receiving an authentication success notification from the authentication server 10, the user management unit 402 passes a common ID (wallet address) included in the authentication success notification to the ticket control unit 403, the information providing unit 404, and the coupon providing unit 405.

In a case where the user who has logged in to an account performs a predetermined operation (for example, pressing a ticket use button) on the regional application, the ticket control unit 403 acquires a reward NFT stored in a wallet of the user.

Specifically, the ticket control unit 403 acquires the reward NFT owned by the user from a blockchain by using the common ID (the wallet address) of the user.

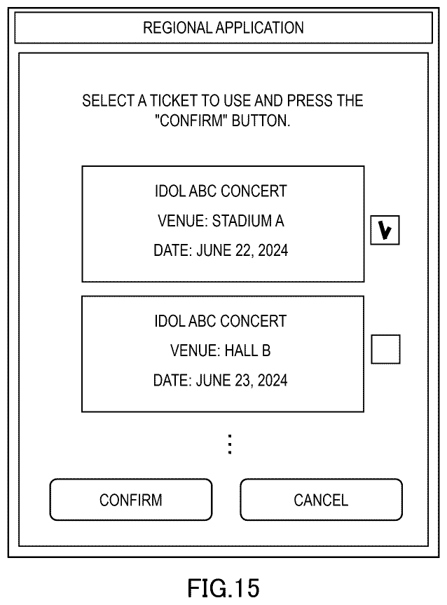

The ticket control unit 403 displays information of the reward ticket acquired from the acquired reward NFT on the terminal 40 and specifies a reward ticket that the user desires to use. For example, the ticket control unit 403 may display a GUI as shown in FIG. 15 on the terminal 40 and specify the reward ticket that the user desires to use.

The ticket control unit 403 displays information related to the specified reward ticket on the terminal 40.

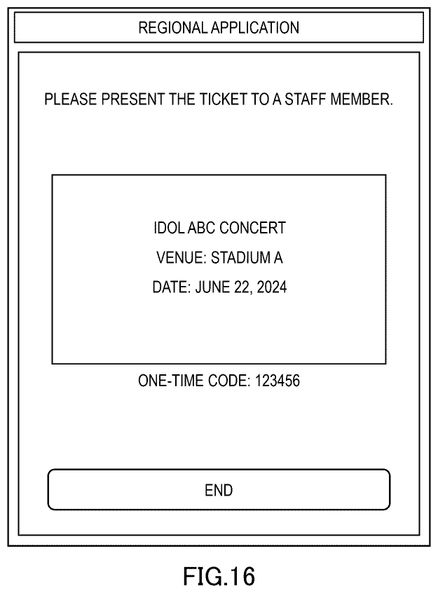

At that time, the ticket control unit 403 may generate a one-time code for preventing unauthorized use of the reward ticket. The ticket control unit 403 may display the generated one-time code together with information related to the reward ticket on the terminal 40 of the user (see FIG. 16). It should be noted that the ticket control unit 403 regenerates the one-time code at a predetermined interval and updates the one-time code displayed on the terminal 40.

Further, the ticket control unit 403 displays the generated one-time code also on a staff terminal 41 possessed by a staff member of an event venue.

In this case, the staff member installs a dedicated application on the staff terminal 41. In a case where the dedicated application is activated, the staff terminal 41 accesses the regional application server 30.

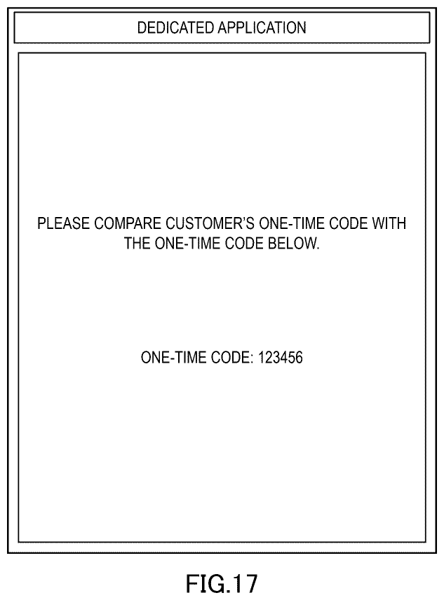

The ticket control unit 403 displays a screen as shown in FIG. 17 on the staff terminal 41 via the dedicated application. The ticket control unit 403 displays the same one-time code on both the terminal 40 and the staff terminal 41. It should be noted that information related to the reward ticket may also be displayed together with the one-time code on the staff terminal 41.

The information providing unit 404 is means for providing sightseeing information related to a sightseeing area to a user.

In a case where a user who has logged in to an account performs a predetermined operation (for example, pressing a sightseeing information acquisition button) on the regional application, the information providing unit 404 provides sightseeing information to the user. The sightseeing information provided to the user is previously registered in the regional application server 30 by a person in charge of a tourist association or the like.

The coupon providing unit 405 is means for distributing a coupon to a user.

In a case where a user who has logged in to an account performs a predetermined operation (for example, pressing a coupon acquisition button) on the regional application, the coupon providing unit 405 distributes a coupon to the user.

The coupon distributed to a user is previously registered in the regional application server 30 by the person in charge of the tourist association or the like. For example, a coupon usable at a restaurant or the like in the sightseeing area is distributed to the user. The user is able to receive a predetermined discount or the like by presenting the distributed coupon to a clerk of the restaurant or the like.

The storage unit 406 is means for storing information necessary for an operation of the regional application server 30.

### [Terminal]

Examples of the terminal 40 include a mobile terminal device such as a smartphone, a mobile phone, a game console, a tablet, an HMD (Head Mounted Display), smart glasses, or the like. The terminal 40 can be any equipment or device as long as the terminal 40 can accept an operation by a user and can communicate with the authentication server 10 or the like. Further, since the configuration or the like of the terminal 40 is obvious to those skilled in the art, a detailed description will be omitted.

### [System Operation]

Next, operations of the information processing system according to the first example embodiment will be described.

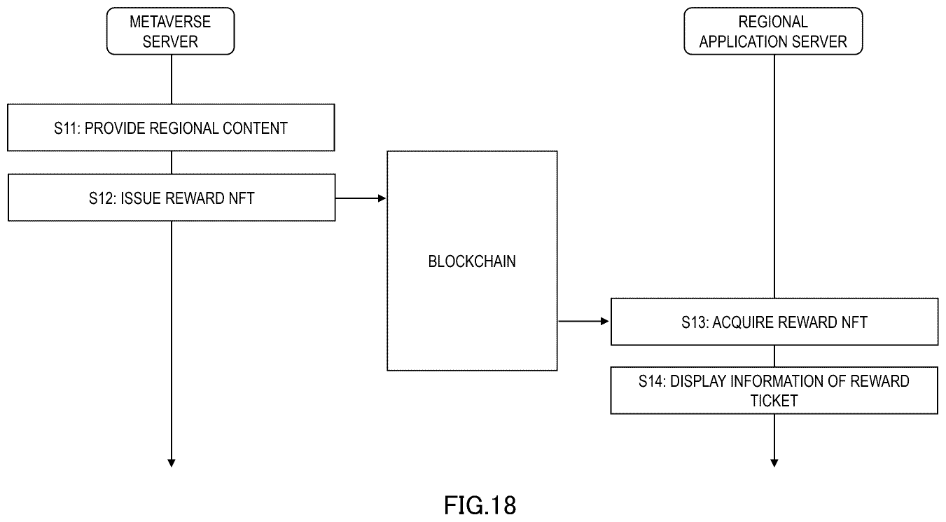

FIG. 18 is a sequence diagram illustrating an example of an operation of the information processing system according to the embodiment disclosed in the present application. Referring to FIG. 18, the operation of the information processing system according to the first example embodiment will be described.

The metaverse server 20 provides regional content to a user (step S11).

The metaverse server 20 issues a reward NFT to the user who has experienced the regional content (step S12).

In a case where the user desires to use a reward ticket at an event venue or the like, the regional application server 30 acquires the reward NFT owned by the user from a blockchain (step S13).

The regional application server 30 displays information of the reward ticket acquired from the acquired reward NFT on the terminal 40 (step S14).

At that time, the regional application server 30 may display a one-time code on the terminal 40 to prevent unauthorized use of the reward ticket. Further, the regional application server 30 may display the same one-time code as that displayed on the terminal 40 also on the staff terminal 41 possessed by a staff member of an event.

Next, variations according to the first example embodiment will be described.

### <Variation 1>

The metaverse server 20 may provide, on the regional metaverse, a field modeled on a sightseeing area and a sightseeing spot of a region (a field in which a user can move on the metaverse). In this case, the metaverse server 20 may determine a preference and taste of the user based on an action of the user in the regional metaverse.

For example, the metaverse control unit 303 of the metaverse server 20 may calculate preferences and tastes such as “likes shrines” and “likes the sea” based on the places visited by the user on the regional metaverse. Alternatively, the metaverse control unit 303 may calculate a preference and taste such as “likes cycling” in a case where the user moves using a bicycle.

The metaverse server 20 may guide a sightseeing spot to the user or distribute a coupon to the user based on the calculated preference and taste.

Alternatively, the preference and taste calculated by the metaverse server 20 may be shared with the regional application server 30. In this case, the metaverse control unit 303 transmits the calculated preference and taste together with a common ID of the user to the regional application server 30. The information providing unit 404 and the coupon providing unit 405 of the regional application server 30 may provide information and distribute a coupon based on the preference and taste of the user.

### <Variation 2>

In the above embodiment, a case where the user generates an account by inputting a name, a gender, a date of birth, an address, or the like into the authentication server 10 has been described. However, inputting the personal information may be an optional item at the time of account generation.

Alternatively, a benefit may be granted to a user who inputs attribute information such as a gender, a date of birth, an address, or the like into the authentication server 10. For example, in a case where the regional application server 30 acquires attribute information such as a gender, a date of birth, an address, or the like from the authentication server 10, the regional application server 30 may grant a reward NFT corresponding to the acquired address to the user. For example, a resident of a region A may be granted a reward NFT limited to residents of the region A by disclosing their own address to a tourist association or an event organizer of the region.

Further, in disclosing personal information (attribute information), the authentication server 10 may realize selective information disclosure by the user. For example, the user management unit 202 of the authentication server 10 may allow a selection such as “disclose the prefecture of the address but not disclose the municipality.”

### <Variation 3>

The authentication server 10 may perform identity verification using an identification card possessed by a user at the time of user registration. For example, the user management unit 202 of the authentication server 10 may perform identity verification of the user by using a public identification card such as a driver's license, a passport, a My Number Card, or the like.

Specifically, the user management unit 202 of the authentication server 10 acquires biometric information of the user via the regional application. For example, the regional application photographs the user by so-called self-photographing and acquires a face image of the user.

Thereafter, the regional application acquires biometric information or the like from the identification card possessed by the user. For example, the regional application reads out a face image, a name, a date of birth, or the like from an IC (Integrated Circuit) chip of the passport, the driver's license, the My Number Card, or the like.

The regional application transmits a face image acquired by self-photographing and a face image acquired from the identification card to the authentication server 10. The user management unit 202 of the authentication server 10 performs identity verification (one-to-one authentication) using the two pieces of biometric information.

In a case where identity verification succeeds, the user management unit 202 acquires a name or the like of the user and generates an account.

<Variation 4>In the above embodiment, a case where each of the authentication server 10, the metaverse server 20, and the regional application server 30 uses a wallet address of a user as a common ID has been described. However, each server may manage users by using an individual ID without using the common ID.

In this case, the user generates an account respectively in the authentication server 10, the metaverse server 20, and the regional application server 30, and registers a user ID in each account. The authentication server 10 acquires, from the user, the user IDs set in the metaverse server 20 and the regional application server 30.

The authentication server 10 respectively stores, in the account of the user, the user ID set in the metaverse server 20 and the user ID set in the regional application server 30.

In a case where the authentication server 10 succeeds in authenticating the user who attempts to log in to the metaverse server 20 or the regional application server 30, the authentication server 10 transmits an authentication success notification including the user ID set in the metaverse server 20 or the regional application server 30 to the metaverse server 20 or the like.

### <Variation 5>

The metaverse server 20 may attach a digital signature to a reward ticket. The metaverse control unit 303 of the metaverse server 20 may issue a reward NFT including a digital signature and register the reward NFT on a blockchain.

In this case, in a case where the regional application server 30 succeeds in verifying the digital signature acquired from the reward NFT, the regional application server 30 may permit the user to use the reward ticket. That is, the ticket control unit 403 of the regional application server 30 may permit the user to use the reward ticket in a case where the reward ticket has been issued by a legitimate metaverse server 20.

### <Variation 6>

A reward ticket (a reward NFT) granted to a user may be resold. In this case, the regional application server 30 may be included with a function as a marketplace.

Alternatively, in a case where the reward ticket granted to the user is set to be non-transferable, the metaverse server 20 may issue an SBT (Soul-Bound Token) instead of an NFT. Alternatively, the metaverse server 20 may issue either an NFT or an SBT depending on the regional content experienced by the user.

Alternatively, the metaverse server 20 may issue a digital certificate using a Public Key Infrastructure (PKI; Public Key Infrastructure) as a reward ticket. Alternatively, the metaverse server 20 may issue a credential certificate (VCs; Verifiable Credentials), which allows online verification of the contents, as a reward ticket.

In a case where the digital certificate or the credential certificate is issued, the regional application server 30 verifies a digital signature attached to these certificates. In a case where the verification of the digital signature succeeds, the regional application server 30 may permit the user to use the reward ticket.

Further, in a case where the digital certificate by PKI or the credential certificate by PKI is issued, these certificates may be managed by a wallet of the user, or may be managed by an account of the regional application server 30 or the metaverse server 20.

### <Variation 7>

The above embodiment has described a case where the authentication server 10 performs authentication of a user. However, the authentication may be performed on the terminal 40 possessed by the user.

In this case, for example, at an initial startup of the regional application or the like, the regional application performs identity verification using an identification card such as a My Number Card. In a case where the identity verification succeeds, the regional application stores biometric information of the user (for example, biometric information acquired by photographing or biometric information acquired from the identification card).

Further, in a case where the authentication server 10 generates an account and a wallet of the user, the authentication server 10 transmits a common ID (a wallet address) to the terminal 40. The terminal 40 stores the common ID.

In a case where a redirection for login is received from the terminal 40, the authentication server 10 instructs the terminal 40 (the regional application) to perform identity verification. In response to the instruction, the terminal 40 performs identity verification using biometric information stored inside and biometric information acquired by self-photographing.

In a case where the identity verification succeeds, the terminal 40 transmits the common ID to the authentication server 10. The authentication server 10 that has received the common ID determines that the authentication of the user has succeeded and notifies the login destination server (the metaverse server 20 or the regional application server 30) of the success.

### <Variation 8>

The system configuration shown in FIG. 3 is an example. For example, the regional application server 30 may be provided with functions of the authentication server 10 and the metaverse server 20. Alternatively, the metaverse server 20 and the regional application server 30 may be integrated.

As described above, in the information processing system according to the first example embodiment, the authentication server 10 authenticates a person to be authenticated who attempts to log in to the metaverse server 20 or the regional application server 30. In a case where the authentication succeeds, the authentication server 10 notifies the login destination server (the metaverse server 20, the regional application server 30) of the success together with a common ID (a wallet address) of the user. The metaverse server 20 and the regional application server 30 identify the user based on the common ID and provide services to the identified user. Specifically, the metaverse server 20 provides regional content on the metaverse and grants a benefit that can be enjoyed in the region to the user who has experienced the content. The metaverse server 20 issues an NFT related to the benefit granted to the user. Further, in a case where the user to whom the benefit has been granted enjoys the benefit in a region in the real world, the regional application server 30 acquires the NFT from a blockchain. The regional application server 30 performs control related to the provision of the benefit granted to the user by using the acquired NFT. As described above, in the information processing system according to the first example embodiment, the user is managed by the common ID, and the identity between the person who is granted a benefit on the metaverse and the person who uses the benefit in the real world is ensured by biometric authentication of the authentication server 10.

In recent years, revitalization of regional economies in sightseeing areas or the like has been required. Meanwhile, utilization of the metaverse for attracting tourists is being explored, and pioneering examples are beginning to emerge. Therefore, it is envisioned to establish a use case in which a user can utilize a benefit acquired on the metaverse at a sightseeing area. That is, by utilizing the metaverse not only as an advertising medium for attracting tourists but also for stimulating consumption at sightseeing areas, revitalization of regional economies can be expected. In addition, in recent years, digitalization of rights using blockchain technology has been attracting attention. Specifically, examples of utility NFTs that allow only NFT owners to participate in exclusive events are beginning to emerge. In consideration of such a situation, it is also envisioned that NFTs are utilized for benefits acquired on the metaverse in the above-described use case. In order to establish such a use case, a mechanism for ensuring that a person who acquires a benefit (a reward NFT) on the metaverse and a person who uses the reward NFT at the local site (sightseeing area) are the same is required. The information processing system according to the present disclosure manages a person on the metaverse and a person in the real world by a common ID, and ensures their identity by authenticating these persons through biometric authentication.

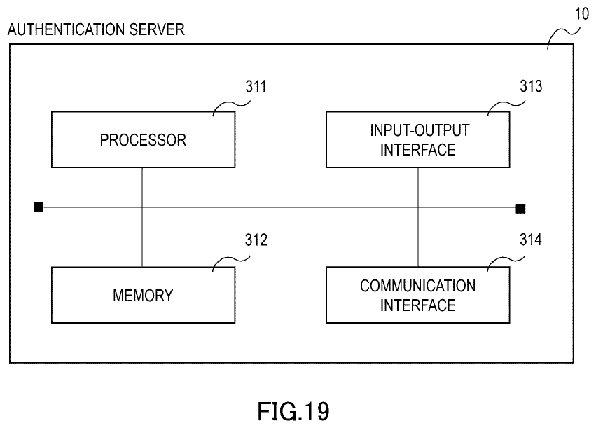

Next, a hardware configuration of an individual apparatus that constitutes the information processing system will be described. FIG. 19 is a diagram illustrating an example of a hardware configuration of the authentication server 10.

The authentication server 10 can be configured by an information processing apparatus (a so-called computer) and has a configuration illustrated as an example in FIG. 19. For example, the authentication server 10 includes a processor 311, a memory 312, an input-output interface 313, a communication interface 314, or the like. The components such as the processor 311 are connected to an internal bus, and so on so that these components can communicate with each other.

However, the configuration shown in FIG. 19 is not intended to limit the hardware configuration of the authentication server 10. The authentication server 10 may include hardware not illustrated in the figure, and may omit the input-output interface 313 as needed. In addition, the number of components such as the processor 311 included in the authentication server 10 is not intended to be limited to the example shown in FIG. 19, and, for example, a plurality of processors 311 may be included in the authentication server 10.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus not illustrated. The display apparatus is, for example, a liquid crystal display or the like. For example, the input apparatus is an apparatus that receives user operations, and examples of the input apparatus include a keyboard and a mouse or the like.

The communication interface 314 is a circuit, a module, or the like for performing communication with other apparatuses. For example, the communication interface 314 includes a NIC (Network Interface Card) or the like.

The functions of the authentication server 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

It should be noted that the metaverse server 20, the regional application server 30, or the like can also be configured by information processing apparatuses in the same manner as the authentication server 10, and since the specific hardware configurations of the metaverse server 20, the regional application server 30, or the like are not different from that of the authentication server 10, a detailed description thereof will be omitted.

The authentication server 10, which is an information processing apparatus, includes a computer, and the functions of the authentication server 10 can be realized by causing the computer to execute a program. In addition, the authentication server 10 executes the control method of the authentication server 10 by the program. Similarly, the metaverse server 20 includes a computer and can realize its functions by causing the computer to execute a program. In addition, the metaverse server 20 executes a control method of the metaverse server 20 by using the program. Similarly, the regional application server 30 includes a computer and can realize the function of the regional application server 30 by causing the computer to execute a program. In addition, the regional application server 30 executes a control method of the regional application server 30 by using the program.

### [Variations]

It should be noted that the configurations, operations, or the like of the information processing system according to the above example embodiment are examples and do not limit the present system configuration, or the like.

In the above embodiment, a case where a participation ticket for an event is granted as a benefit to a user who has experienced regional content has been described. However, the participation ticket is an example of the benefit granted to the user, and other benefits may be granted to the user. For example, a product (for example, goods of an idol or the like) that can be received in a region corresponding to the regional content, or a right to purchase the product, may be the benefit granted to the user who has experienced the regional content.

In the above embodiment, a case where a benefit granted to a user who has experienced regional content is predetermined has been described. However, the benefit to be granted may be selectable by the user from among a plurality of candidates. For example, the metaverse server 20 may present to the user, as possible benefits that can be acquired, a participation ticket for an event and a benefit for acquiring limited goods such as those of an idol, and the user may select either of the benefits.

A plurality of benefits may be granted in response to a single experience of regional content. In the above example, a participation ticket for an event and limited goods may be granted to the user as benefits. Further, in a case where the plurality of benefits are granted to the user, a period during which each benefit can be used may be limited. For example, in the above example, a period during which the event is held and a period during which the limited goods are sold may be different. By setting different periods in which the benefits can be enjoyed, it is expected that the user will visit the region multiple times.

In the above embodiment, a case where a regional application prepared for each region is installed in the terminal 40 has been described. However, a single regional application may correspond to a plurality of regions. Specifically, the user may select, within the regional application, a region in which the user desires to experience content or a region in which the user desires to use a granted benefit.

The authentication server 10 may perform “liveness authentication” for proving that a person to be authenticated actually exists. Specifically, after succeeding in authentication (matching) using biometric information acquired by photographing and biometric information read from the user management database, the authentication server 10 gives an instruction for a predetermined operation to the user and determines whether or not the user (the person to be authenticated) follows the instruction. For example, the authentication server 10 gives an instruction such as “Please close your right eye” and determines whether or not the user actually exists depending on whether or not the user follows the instruction.

In the above embodiment, a case where the authentication server 10 authenticates a person to be authenticated who attempts to log in to the metaverse server 20 or the regional application server 30 by biometric authentication has been described. However, the authentication server 10 may authenticate the person to be authenticated by using another authentication method. For example, the authentication server 10 may authenticate the person to be authenticated by using password authentication employing a password, or knowledge-based authentication using pre-registered questions and answers. Alternatively, the authentication server 10 may authenticate the person to be authenticated by using multi-factor authentication combining biometric authentication and password authentication.

In the above embodiment, a case where a wallet address is used as a common ID of a user has been described. However, other information may be used as the common ID of the user. For example, a digital signature (digital ID) or a decentralized identifier (DID; Decentralized Identifier) may be used as the common ID of the user. Similarly, for an ID of a tourist association, not only a wallet address but also a digital signature (digital ID) or a decentralized identifier (DID) may be used.

In the above embodiment, a case where the user management database is configured inside the authentication server 10 has been described, but the database may be constructed on an external database server or the like. That is, some of the functions of the authentication server 10 may be implemented in another server. More specifically, the “metaverse control unit (metaverse control means)”, the “ticket control unit (ticket control means)”, or the like described above may be implemented in any of the apparatuses included in the system.

While the data exchange between each apparatus (the authentication server 10, the terminal 40, or the like) is not limited to any particular mode, data exchanged between these apparatuses may be encrypted. Among these apparatuses, biometric information or the like is transmitted and received, and in order to appropriately protect such information, it is desirable that encrypted data be transmitted and received.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to an information processing system or the like that grants a benefit, which can be enjoyed in a real space, to a user who has acted in a virtual space.

A part or the entirety of the example embodiments described above may be described as in the following supplementary notes, but is not limited to the followings.

### [Supplementary Note 1]

A system, including:
a regional application server that provides a service related to a predetermined region;
a metaverse server that provides content related to the predetermined region on a metaverse; and
an authentication server that authenticates a user who attempts to log in to the regional application server and the metaverse server, wherein the authentication server notifies, in a case where the authentication server succeeds in authenticating the user who attempts to log in to the metaverse server, the metaverse server of a success of an authentication of the user, and
wherein the metaverse server, in a case where the user determined to have succeeded in the authentication experiences the content related to the predetermined region, grants a benefit that can be enjoyed in the predetermined region to the user who experienced the content and issues a certificate of the granted benefit, and
wherein the authentication server notifies, in a case where the authentication server succeeds in authenticating the user who attempts to log in to the regional application server, the regional application server of a success of an authentication of the user, and
wherein the regional application server acquires, in a case where the user determined to have succeeded in the authentication desires to enjoy the granted benefit, the certificate of the granted benefit and performs control related to a provision of the benefit by using the acquired certificate.

### [Supplementary Note 2]

The system according to supplementary note 1, wherein the metaverse server issue an NFT (Non-Fungible Token) as the certificate of the granted benefit.

### [Supplementary Note 3]

The system according to supplementary note 2, wherein the metaverse server grant, as the benefit that can be enjoyed in the predetermined region, a ticket for an event held in the predetermined region to the user who has experienced the content.

### [Supplementary Note 4]

The system according to supplementary note 3, wherein the regional application server displays information related to the ticket acquired from the NFT on a terminal possessed by the user who has logged in to the regional application server and attempts to enter an event venue using the ticket.

### [Supplementary Note 5]

The system according to supplementary note 4, wherein the regional application server displays, together with the information related to the ticket, a one-time code updated at a predetermined interval on the terminal.

### [Supplementary Note 6]

The system according to supplementary note 5, wherein the regional application server displays, on a staff terminal possessed by a staff member of the event, the displayed one-time code on the terminal.

### [Supplementary Note 7]

The system according to any one of supplementary notes 1 to 6, wherein the authentication server authenticates the user who attempts to log in to the regional application server or the metaverse server using biometric information.

### [Supplementary Note 8]

A method performed in a system, the system including:
a regional application server that provides a service related to a predetermined region;
a metaverse server that provides content related to the predetermined region on a metaverse; and
an authentication server that authenticates a user who attempts to log in to the regional application server and the metaverse server, wherein the authentication server notifies, in a case where the authentication server succeeds in authenticating the user who attempts to log in to the metaverse server, the metaverse server of a success of an authentication of the user, and
wherein the metaverse server, in a case where the user determined to have succeeded in the authentication experiences the content related to the predetermined region, grants a benefit that can be enjoyed in the predetermined region to the user who experienced the content and issues a certificate of the granted benefit, and
wherein the authentication server notifies, in a case where the authentication server succeeds in authenticating the user who attempts to log in to the regional application server, the regional application server of a success of an authentication of the user, and
wherein the regional application server acquires, in a case where the user determined to have succeeded in the authentication desires to enjoy the granted benefit, the certificate of the granted benefit and performs control related to a provision of the benefit by using the acquired certificate.

### [Supplementary Note 9]

The method according to supplementary note 8, wherein the metaverse server issue an NFT (Non-Fungible Token) as the certificate of the granted benefit.

### [Supplementary Note 10]

The method according to supplementary note 9, wherein the metaverse server grant, as the benefit that can be enjoyed in the predetermined region, a ticket for an event held in the predetermined region to the user who has experienced the content.

### [Supplementary Note 11]

The method according to supplementary note 10, wherein the regional application server displays information related to the ticket acquired from the NFT on a terminal possessed by the user who has logged in to the regional application server and attempts to enter an event venue using the ticket.

### [Supplementary Note 12]

The method according to supplementary note 11, wherein the regional application server displays, together with the information related to the ticket, a one-time code updated at a predetermined interval on the terminal.

### [Supplementary Note 13]

The method according to supplementary note 12, wherein the regional application server displays, on a staff terminal possessed by a staff member of the event, the displayed one-time code on the terminal.

### [Supplementary Note 14]

The method according to any one of supplementary notes 8 to 13, wherein the authentication server authenticates the user who attempts to log in to the regional application server or the metaverse server using biometric information.

### [Supplementary Note 15]

A server apparatus, including:
a storage means that stores biometric information of each of a plurality of users; and
an authentication control means that authenticates a person to be authenticated who attempts to log in to a regional application server that provides a service related to a predetermined region or to a metaverse server that provides content related to the predetermined region on a metaverse using the stored biometric information and the biometric information of the person to be authenticated.

### [Supplementary Note 16]

A control method of a server apparatus, the control method comprising:
storing biometric information of each of a plurality of users; and
authenticating a person to be authenticated who attempts to log in to a regional application server that provides a service related to a predetermined region or to a metaverse server that provides content related to the predetermined region on a metaverse using the stored biometric information and the biometric information of the person to be authenticated.

### [Supplementary Note 17]

A program causing a computer mounted on a server apparatus to perform processing for:
storing biometric information of each of a plurality of users; and
authenticating a person to be authenticated who attempts to log in to a regional application server that provides a service related to a predetermined region or to a metaverse server that provides content related to the predetermined region on a metaverse using the stored biometric information and the biometric information of the person to be authenticated.

Furthermore, all or part of the configurations described in supplementary note 2 to supplementary note 7, which depend on supplementary note 1, may also depend on supplementary note 15 to supplementary note 17 in the same manner as supplementary note 2 to supplementary note 7. Furthermore, not limited to supplementary note 15 to supplementary note 17, within the scope that does not deviate from the embodiments described above, all or part of the configurations described as supplementary notes may similarly depend on various hardware, software, various recording means for recording software, or systems.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and spirit of the present invention. That is, the present invention of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. A system, comprising:
a regional application server that provides a service related to a predetermined region;
a metaverse server that provides content related to the predetermined region on a metaverse; and
an authentication server that authenticates a user who attempts to log in to the regional application server and the metaverse server, wherein
the authentication server notifies, in a case where the authentication server succeeds in authenticating the user who attempts to log in to the metaverse server, the metaverse server of a success of an authentication of the user, and
wherein the metaverse server, in a case where the user determined to have succeeded in the authentication experiences the content related to the predetermined region, grants a benefit that can be enjoyed in the predetermined region to the user who experienced the content and issues a certificate of the granted benefit, and
wherein the authentication server notifies, in a case where the authentication server succeeds in authenticating the user who attempts to log in to the regional application server, the regional application server of a success of an authentication of the user, and
wherein the regional application server acquires, in a case where the user determined to have succeeded in the authentication desires to enjoy the granted benefit, the certificate of the granted benefit and performs control related to a provision of the benefit by using the acquired certificate.

2. The system according to claim 1, wherein the metaverse server issue an NFT (Non-Fungible Token) as the certificate of the granted benefit.

3. The system according to claim 2, wherein the metaverse server grant, as the benefit that can be enjoyed in the predetermined region, a ticket for an event held in the predetermined region to the user who has experienced the content.

4. The system according to claim 3, wherein the regional application server displays information related to the ticket acquired from the NFT on a terminal possessed by the user who has logged in to the regional application server and attempts to enter an event venue using the ticket. The system according to claim 4, wherein the regional application 5. server displays, together with the information related to the ticket, a one-time code updated at a predetermined interval on the terminal.

6. The system according to claim 5, wherein the regional application server displays, on a staff terminal possessed by a staff member of the event, the displayed one-time code on the terminal.

7. The system according to claim 1, wherein the authentication server authenticates the user who attempts to log in to the regional application server or the metaverse server using biometric information.

8. The system according to claim 2, wherein the authentication server authenticates the user who attempts to log in to the regional application server or the metaverse server using biometric information.

9. The system according to claim 3, wherein the authentication server authenticates the user who attempts to log in to the regional application server or the metaverse server using biometric information.

10. The system according to claim 4, wherein the authentication server authenticates the user who attempts to log in to the regional application server or the metaverse server using biometric information.

11. The system according to claim 5, wherein the authentication server authenticates the user who attempts to log in to the regional application server or the metaverse server using biometric information.

12. The system according to claim 6, wherein the authentication server authenticates the user who attempts to log in to the regional application server or the metaverse server using biometric information.

13. A server apparatus, comprising:
at least one memory storing a set of instructions; and
at least one processor configured to execute the set of instructions to:
store biometric information of each of a plurality of users; and
authenticate a person to be authenticated who attempts to log in to a regional application server that provides a service related to a predetermined region or to a metaverse server that provides content related to the predetermined region on a metaverse using the stored biometric information and the biometric information of the person to be authenticated.

14. A control method of a server apparatus, the control method comprising:
storing biometric information of each of a plurality of users; and
authenticating a person to be authenticated who attempts to log in to a regional application server that provides a service related to a predetermined region or to a metaverse server that provides content related to the predetermined region on a metaverse using the stored biometric information and the biometric information of the person to be authenticated.
